(19) United States
(12) Patent Application Publication
(10) Pub. No.: US 2013/0056350 A1
(43) Pub. Date: Mar. 7, 2013

(54) ION WATER DEVICE

(71) Applicant: Jong-Ho Sin, Seongnam-si (KR)

(72) Inventor: Jong-Ho Sin, Seongnam-si (KR)

(73) Assignee: IONFARMS CO., LTD., Bupyeng-gu, Incheon (KR)

(21) Appl. No.: 13/578,349

(22) PCT Filed: Apr. 6, 2011
(86) PCT No.: PCT/KR11/02344

§ 371 Date: Aug. 10, 2012

(30) Foreign Application Priority Data
May 17, 2010 (KR) 10-2010-0045882

(51) Int. Cl. C02F 1/461

(52) U.S. Cl. 204/230.5

(57) ABSTRACT

An ion water device, constructed with an ionization container holding raw water to be ionized; and an ionizing electrode unit disposed at one side of the ionizing container, with only one electrode, either an anode or a cathode, directly contacting the raw water. An ionization water control unit controls the ionizing electrode unit in accordance with a user's signal, and a power supply supplying electrode power to the ionizing electrode unit according to a control of the ionizing control unit.

### CLAIM OF PRIORITY

This application makes reference to, incorporates the same herein, and claims all benefits accruing under 35 U.S.C. §119 from applications filed in the Korean Intellectual Property Office on 17 May 2010 and there duly assigned Serial No. 10-2010-0045882, Furthermore, this application makes reference to, incorporates the same herein, and claims all benefits accruing under 35 U.S.C. §365(c) of my PCT International application entitled ION WATER DEVICE Filed on 6 Apr. 2011 and duly assigned Serial No. PCT/KR2011/002344.

### BACKGROUND OF THE INVENTION

1. Field of the Invention

Embodiments of the present invention relate to an ion water device, and in particular, to an easily portable ion water device which may minimize waste of raw water, prevent damage to electrodes and ion partitions of the ion water device, and provide either alkaline water or acidic water in dependence upon a user's selection.

2. Description of the Related Art

Water is vital to life and exists almost everywhere on the earth. Most of fresh water has substantially equal hydrogen ions (H⁺) and hydroxyl ions (OH⁻). Water becomes acidic water with when the concentration of hydrogen ions (H⁺) exceeds that of hydroxyl ions (OH⁻). On the other hand, water becomes alkaline water when the concentration of hydroxyl ions (OH⁻) exceeds that of hydrogen ions (H⁺). Acidic water and alkaline water may be directly obtained from nature. Acidic water and alkaline water may also be produced by controlled apparatus and processes, for example, by ionization water apparatus based on electrolysis processes.

Today, acidic water and alkaline water produced by ionization water apparatus is widely used. For example, acidic water can be used for skin care. Human hair and skin is actually mildly acidic, which allows for the water to interact with it beneficially. Acidic water has the ability to restore sheen to hair as well as thickness of body. Acidic water can also promote smoothness and tightness of skin. For another example, acidic water may also be used for cleaning and disinfecting because of its acidic property. Alkaline water produced by an ion water device is also beneficial to human beings. For example, drinking alkaline water may help to reduce the overall acidity level of human body, making human being more resistant to disease.

In the present invention, ionized water means either acidic water or alkaline water, or both. Raw water means the water supplied to an ion water device for producing ionized water.

An ion water device may be formed with two electrolysis cells separated by an ion partition allowing only ions to pass through, and an electrolysis electrode disposed at each electrolysis cell.

Since contemporary ion water devices are bulky and is a fixed type is usually to be installed as auxiliary equipment, it is inconvenient for a user to carry.

Furthermore, the contemporary ionization water devices with the above-mentioned features is directed to selectively using one of the ionized water, produced either alkaline water or acidic water, depending on a user's needs, and most of the other non-selected ionized water, acidic water or alkaline water, is discharged and wasted. Therefore the quantity of the raw water that is consumed during the production of ionized water is excessive.

Moreover, dissolved solid substances contained in the raw water, such as calcium, magnesium, etc., may attach on the electrodes of the ion water device during the ionization process for production of raw water; adversely, the ion partitions of the ion water device may he clogged and damaged.

### SUMMARY OF THE INVENTION

It is an object of the present invention to provide an ion water device which may resolve the problems encountered in contemporary art.

These and other objects may be attained with embodiments of the present invention may be practiced with an ion water device which may be constructed with an ionization container having sufficient volume to store raw water for ionization; an ionization electrode disposed at one side of the ionization container allowing either an anode or a cathode of the ionization electrode part to be in direct contact with the raw water; an ionization water controller which is provided at one side of the ionization container controlling the ionization electrode; a manipulation part inputting a user's manual signal to the ionization water controller; and an electric power source supplying electric power to the ionization electrode part in accordance with a user's manual signal that has been applied to control the ionization water controller.

The practice of the present invention provides an ionization electrode part in which only one electrode positioned between an anode and a cathode comes into contact with raw water in an ionization container formed of one electrolysis cell in an ion water device, so the structure of the ion water device is simplified, the ion water device is potable and easy to carry by hand, the loss of the raw water is minimized during the production of ionized water, the ionized water can be selectively used by a user based on a user's selection, and the functionality of the ion water device is enhanced.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded assembly view of an embodiment of the present invention;

FIG. 2 is an oblique view illustrating an engagement of an embodiment of the present invention;

FIG. 3 is a cross-sectional view of an embodiment of the present invention;

FIG. 4 is a cross-sectional view illustrating a construction of an insulated coating layer formed at a surface of an externally contacting electrode of an ionization electrode part according to an embodiment of the present invention;

FIG. 5 is a cross-sectional view illustrating a construction of an ozone degradation part formed from an ozone degradation catalyst according to an embodiment of the present invention;

FIG. 6 is a cross-sectional view illustrating a construction of an ozone degradation part formed from active carbon according to another embodiment of the present invention;

FIG. 7 is an exploded assembly view illustrating the construction of an ionization electrode part formed in a cylindrical shape as an embodiment of the present invention;

FIG. 8 is an oblique view illustrating the construction of an ionization electrode part formed in a cylindrical shape as an embodiment of the present invention;

FIG. 9 is a cross-sectional view illustrating the construction of an ionization electrode part formed in a cylindrical shape as an embodiment of the present invention;

FIG. 10 is an exploded assembly view illustrating the construction of an ionization electrode part formed in a circular plate shape as an embodiment of the present invention;

FIG. 11 is an oblique view illustrating the construction of an ionization electrode part formed in a circular plate shape as an embodiment of the present invention;

FIG. 12 is a cross-sectional view illustrating the construction of an ionization electrode part formed in a circular plate shape as an embodiment of the present invention;

FIG. 13 is an exploded assembly view illustrating a construction of an ionization container formed of a kettle according to the principles of the present invention; and

FIG. 14 is a schematic view of a contemporary apparatus for producing ionized water.

### DETAILED DESCRIPTION OF THE INVENTION

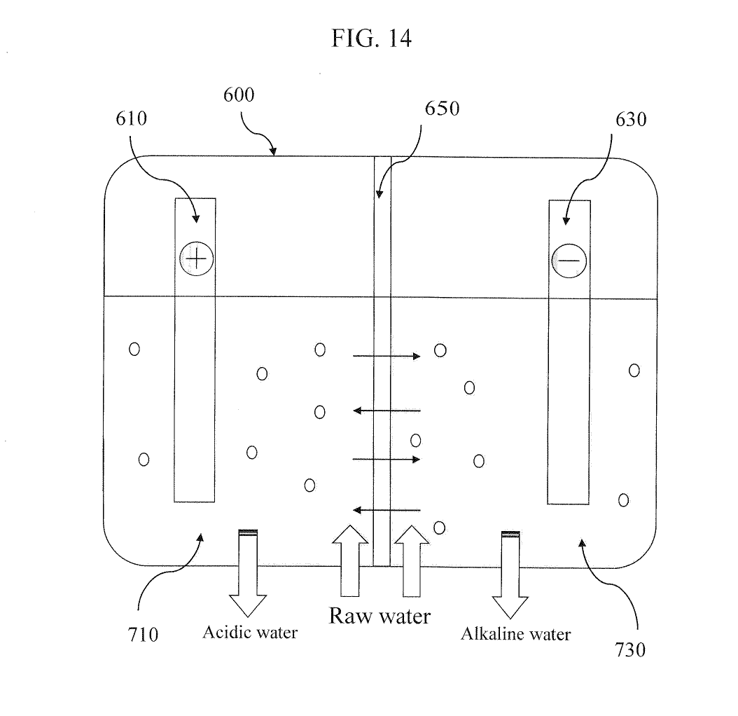

Turning now to the drawings, FIG. 14 shows an embodiment of an ionization water apparatus 600. The apparatus 600 has two electrolysis cells 710 and 730 separated by an ion partition 650 constructed in accordance with contemporary principles. The ion partition 650 allows only ions to pass through. An anode electrode 610 and a cathode electrode 630 are placed in the electrolysis cells 710 and 730, respectively. The raw water supplied to the electrolysis cell 710 becomes acidic water while the raw water supplied to the electrolysis cell 730 becomes alkaline water, after an electrolysis process has been conducted.

The contemporary ion water device with the above-mentioned features is directed to selectively using one of the ionized water that is either the alkaline water or acidic water, in dependence upon a user's needs, and most of the other non-selected ionized water, acidic water or alkaline water, is discharged and wasted; therefore the quantity of the raw water that is consumed during the contemporary production of ionized water is excessive.

The present invention is directed to an easily carriable ion water device which may minimize waste of raw water in the production of ionized water and prevent damage to an electrode and to an ion partition of the ion water device that would otherwise be caused by the dissolved solid substances entrained in the raw water.

The preferred embodiments of the present invention will now be described in detail with reference to the accompanying drawings.

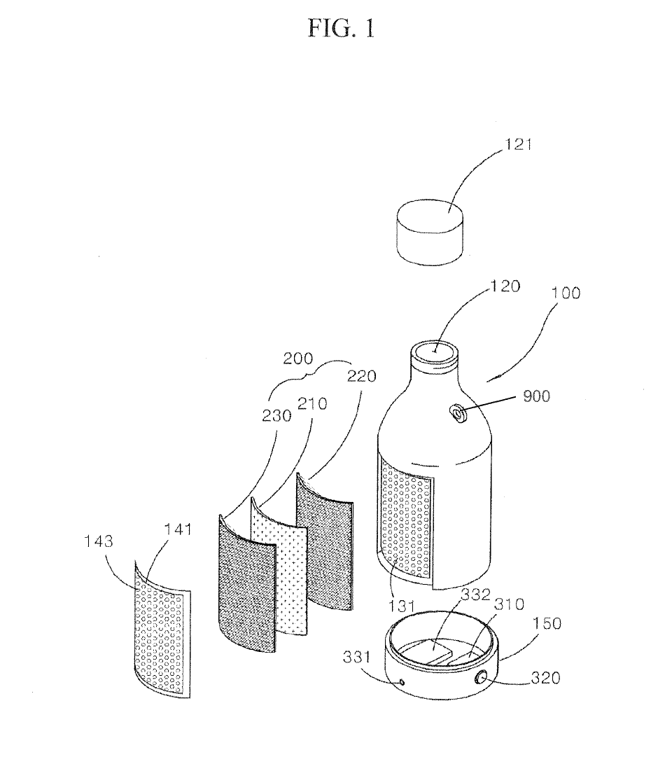

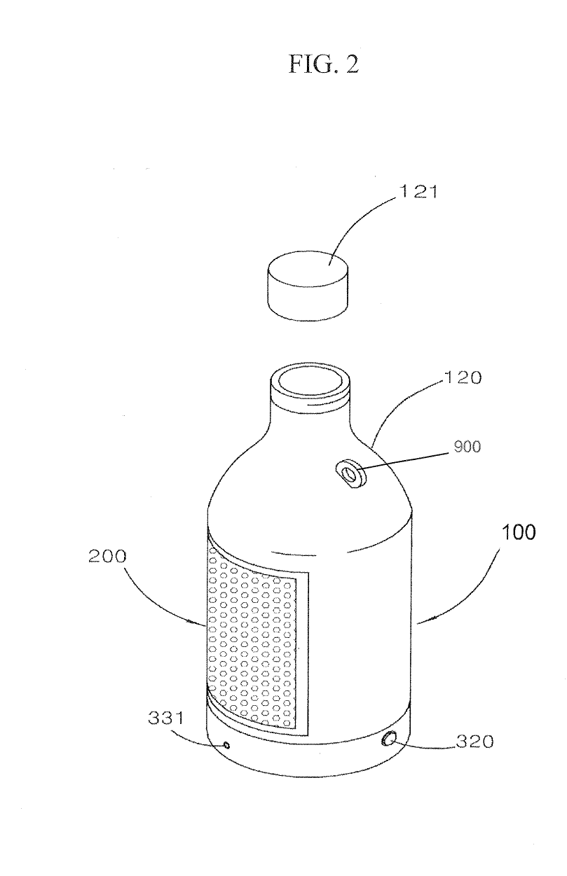

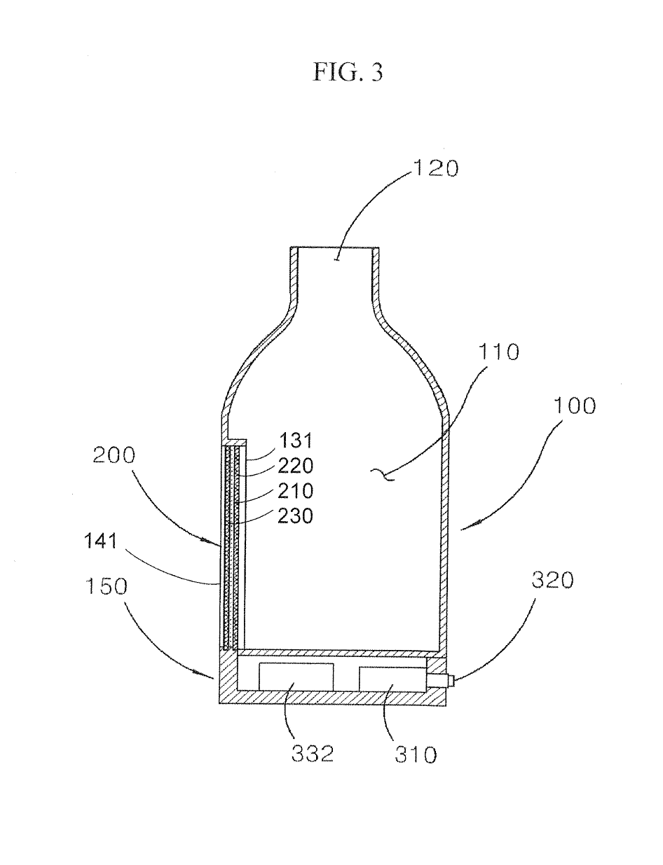

As shown in FIGS. 1 through 3, an ion water device according to the present invention may include an ionization container 100 which has a certain volume sufficient to store raw water for ionization and forms an ionization chamber 110. An ionization electrode assembly 200 disposed at one side of the ionization container 100 allows either an anode or a cathode of the ionization electrode assembly 200 to be in direct contact with the raw water. An ionization water controller 310 disposed at one side of the ionization container 100 controls the ionization electrode assembly 200. A manipulation part 320, such as a manual or automatic switch, disposed at one side of the ionization container 100 receives a user's manipulation signal applied to the ionization water controller 310. An electric power part disposed at one side of the ionization container 100 supplies electric power to the ionization electrode assembly 200 in accordance with and under the control of the ionization water controller 310.

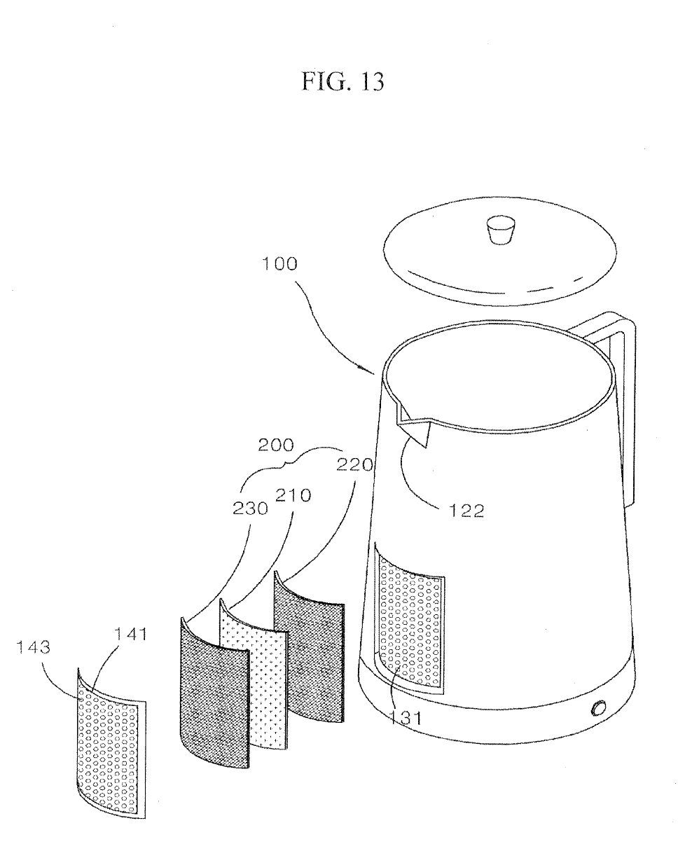

Preferably, the ionization container 100 has an outlet 120. The outlet 120 is open at the upper side to receive raw water and discharge ionized water. A lid 121 may be provided to cover the outlet 120. According to embodiments of the present invention, the outer shape of the ionization container 100 may be constructed with a shape, such as a cylindrical bottle shape, a rectangular bottle shape, a bucket shape, and a kettle shape similar to that of a coffee pot. The ionization container 100 may include a handle 900 disposed on an outer surface of the ionization container 100. A user may use the handle 900 when the user carries the ion water device. As shown in FIG. 13, the kettle shaped ionization container 100 may have an outlet port 122.

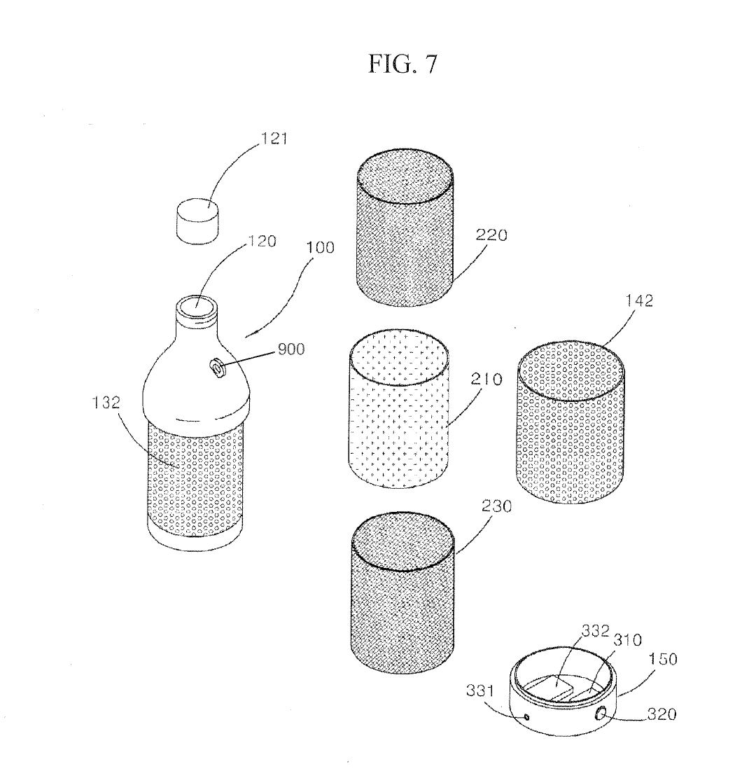

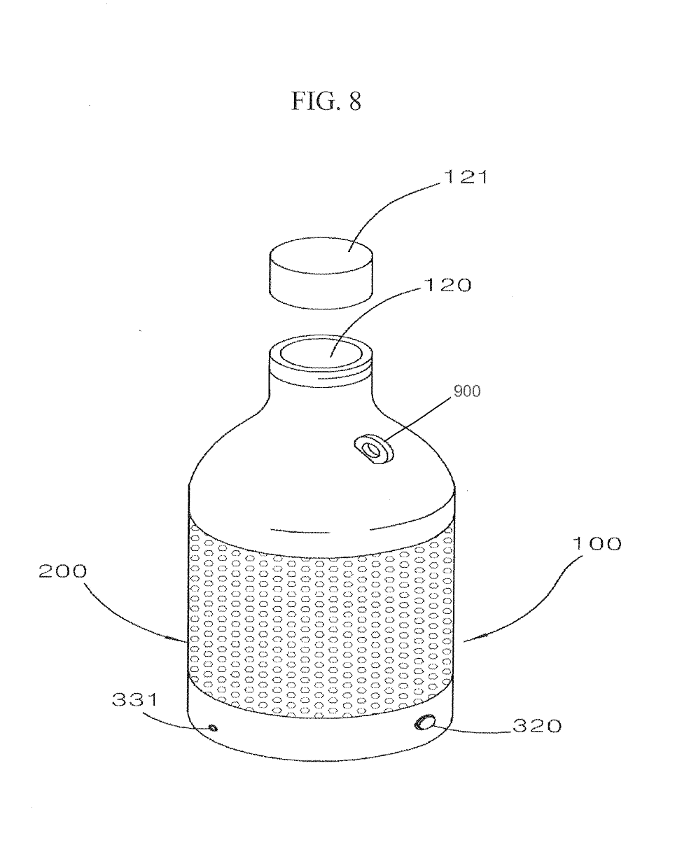

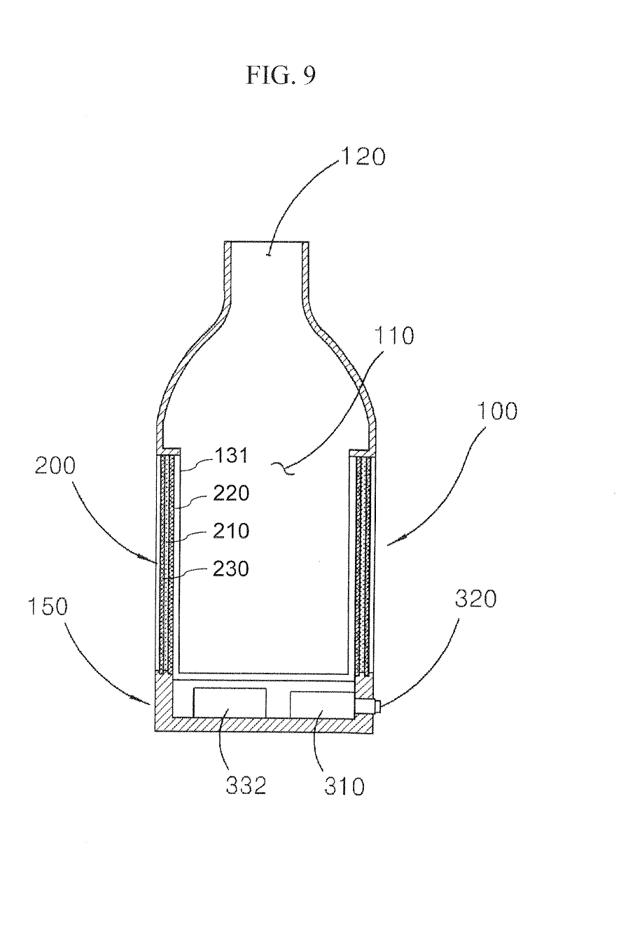

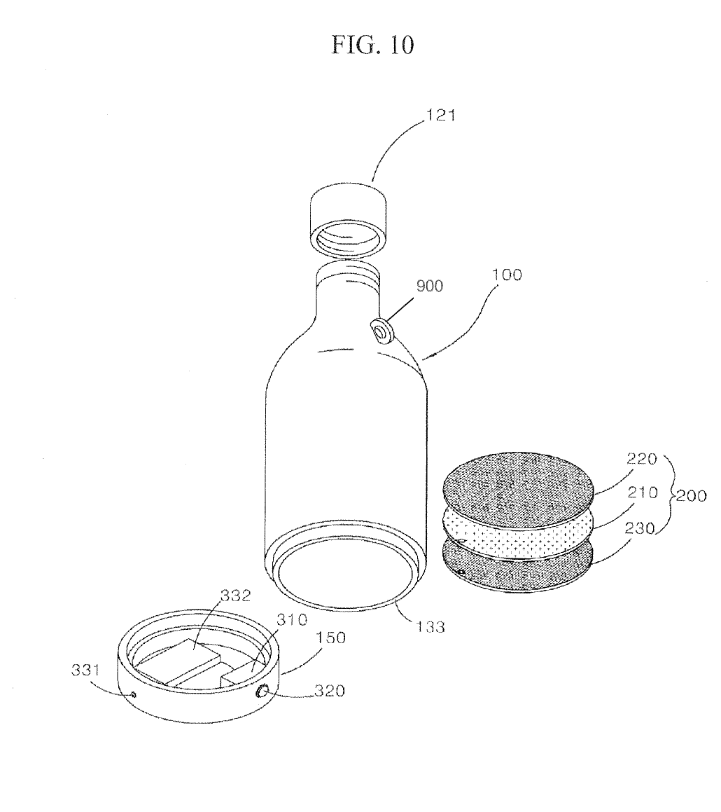

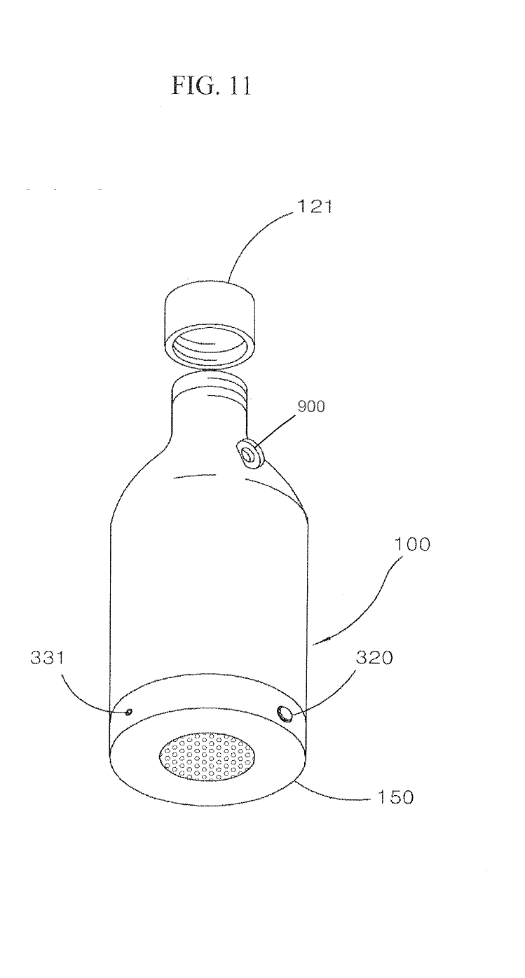

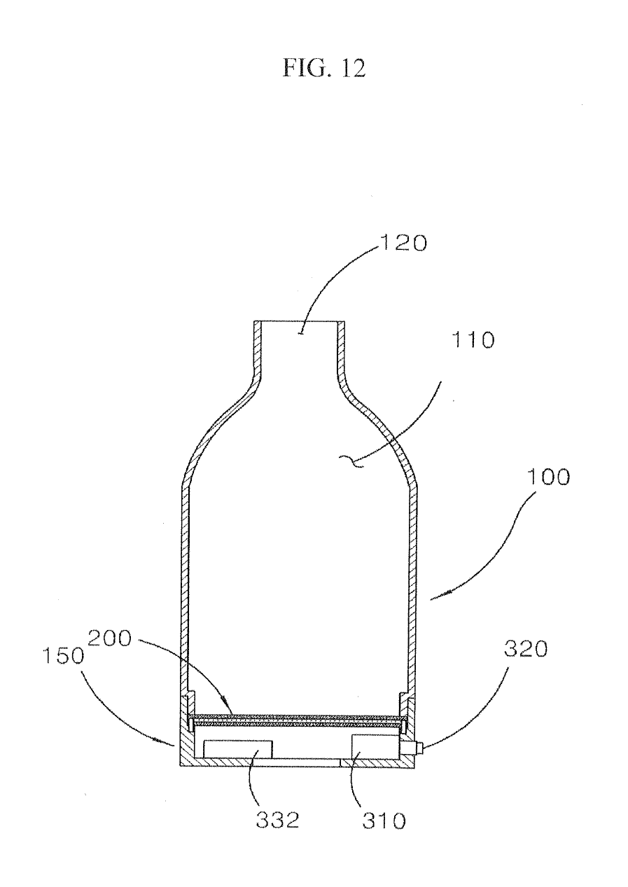

According to exemplary embodiments, the ionization electrode assembly 200 may be formed with a shape such as an accurately curved rectangular plate shape cut as a segment as shown in FIGS. 1 to 3, a circular cylindrical shape as shown in FIGS. 7 to 9, or a circular plate shape as shown in FIGS. 10 to 12. More specifically, the ionization electrode assembly 200 may have a raw water contact electrode 220, an externally exposed electrode 230, and an ion partition 210 sandwiched between the raw water contact electrode 220 and the externally exposed electrode 230. The ion partition 210, which only allows ion substances to pass through, may be formed as either a proton exchange membrane or a polymer electrolyte membrane. The raw water contact electrode 220 may allow ion substances to pass through. One surface of the raw water contact electrode 220 on the opposite or interior side of the ion partition 210 may be configured to be in direct contact with the raw water. The externally exposed electrode 230 may allow oxygen and ozone or hydrogen gas generated in the ionization process to pass through. One surface of the externally exposed electrode 230 on the opposite or outer side of the ion partition 210 may be configured to externally expose to air.

When the ionization water controller 310 receives a signal applied to the user manipulation part 320 which indicates a user's selection between alkaline water and acidic water, the ionization water controller 310 may regulate voltages applied to each of the raw water contact electrode 220 and the externally exposed electrode 230. More specifically, when the ionization water controller 310 receives a signal indicating that alkaline water is the preferred ionized water, the ionization water controller 310 regulates a relatively low voltage applied to the raw water contact electrode 220 and a relatively high voltage applied to the externally exposed electrode 230. In this case, the raw water contact electrode 220 serves as a cathode electrode and the externally exposed electrode 230 serves as an anode electrode, respectively. On the other hand, when the ionization water controller 310 receives a signal indicating that acidic water is the preferred ionized water, the ionization water controller 310 regulates a relatively high voltage applied to the raw water contact electrode 220 and a relatively low voltage applied to the externally exposed electrode 230. In this case, the raw water contact electrode 220 serves as an anode electrode and the externally exposed electrode 230 serves as a cathode electrode, respectively.

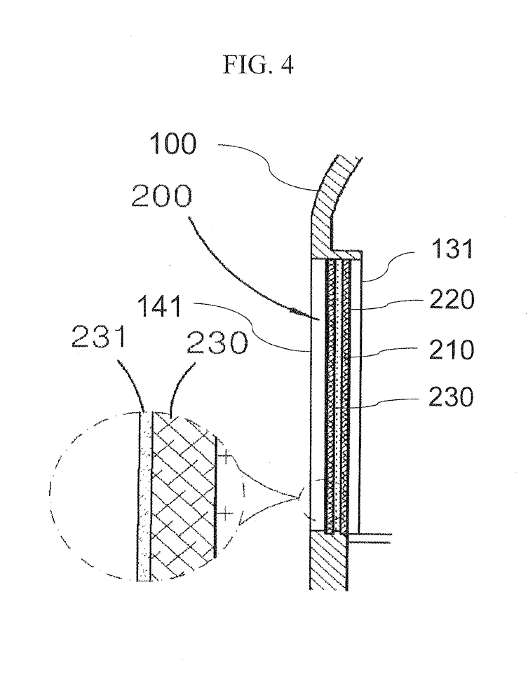

Each of the raw water contact electrode 220 and the externally exposed electrode 230 may be formed either as a net shaped plate or a porous plate. As shown in FIG. 4, an insulated coating layer 231 may be formed at an outer surface of the externally exposed electrode 230 to prevent oxidation and electric leakage.

Referring back to FIGS. 1 through 3, the ionization electrode part assembly 200 may be configured to have a shape of a curved rectangular plate. In order to accommodate the rectangular ionization electrode assembly 200, a rectangular plate shaped electrode installation part 131 may be formed at a lateral wall of one side or at a lateral interior wall of both sides of the ionization container 100. The rectangular plate shaped electrode installation part 131 is configured to have a match structure corresponding to the rectangular ionization electrode assembly 200; therefore, the rectangular plate-shaped ionization electrode assembly 200 may be coupled to and installed in the rectangular plate shape electrode installation part 131. In addition, a curved rectangular plate shaped electrode cover 141 may be provided to cover the rectangular plate shaped ionization electrode assembly 200 to avoid direct exposure of the rectangular plate shaped ionization electrode assembly 200. Preferably, the rectangular plate shaped electrode 141 may be constructed with at least one ventilation hole 143, and typically, with a plurality of ventilation holes 143, for the exhaust of the gas from the interior of ionization container 100. p In another embodiment as shown in FIGS. 7 to 9, the ionization electrode assembly 200 may be configured to have a circular cylindrical shape. In order to accommodate the cylindrical ionization electrode assembly 200, a cylindrical electrode installation part 132 may be provided at an outer surface the ionization container 100 in order to form a cylindrical support surface that coaxially mates with the inner cylindrical surface of raw water contact electrode 220. And thus, the cylindrical ionization electrode assembly 200 may be inserted coaxially into the cylindrical electrode installation part 132. In addition, a cylindrical electrode cover 142 may be provided to cover an outer surface of the ionization electrode assembly 200 to avoid direct exposure of the cylindrical ionization electrode assembly 200. The cylindrical electrode cover 142 may be constructed with at least one ventilation hole 143 for the exhaust of gas.

In another embodiment as shown in FIG. 10 to 12, the ionization electrode assembly 200 may be configured to have a circular plate shape. In order to accommodate the circular plate shaped ionization electrode assembly 200, a circular plate shaped electrode installation part 133 that exhibits a circular distal rim may be formed at a lower side of the ionization chamber 100. And thus, the circular plate shaped electrode assembly 200 is coupled to ionized and is physically supported by the circular plate shaped electrode installation part 133.

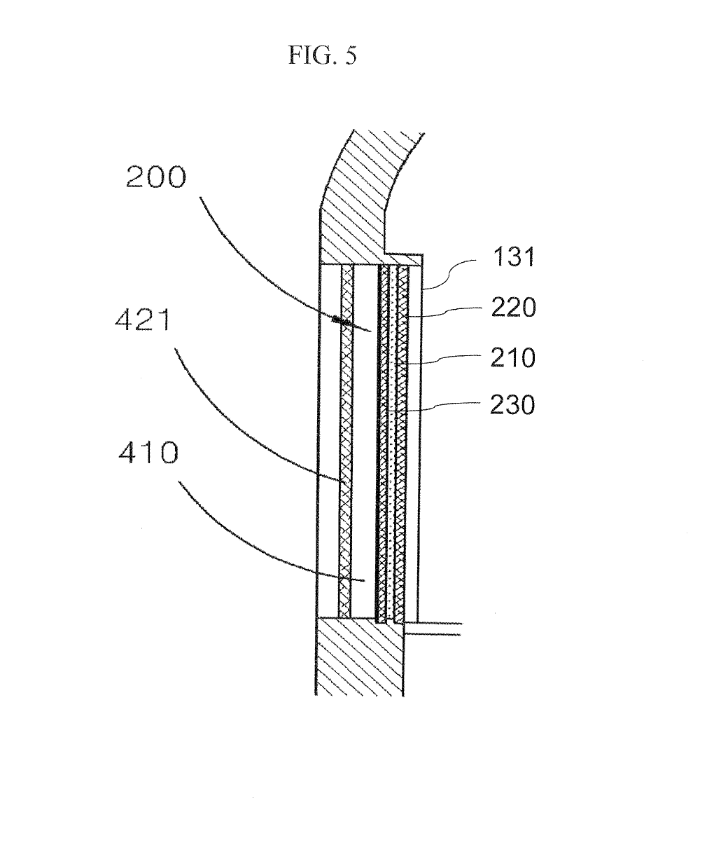

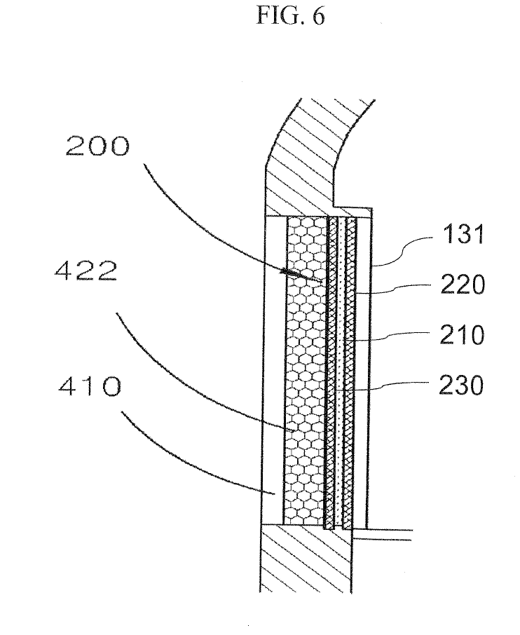

Turning additionally to FIGS. 5 and 6, when alkaline water is selected as the desired ionized water to be produced, ozone may consequently be contained in the oxygen discharged via the externally exposed electrode 230. In order to degrade ozone to oxygen, an ozone degradation chamber 410 may be provided at the side of the externally exposed electrode 230. Furthermore, an ozone degradation stage may be provided at the ozone degradation chamber 410 to improve the efficiency of ozone degradation.

The ozone degradation stage is formed of either an ozone degradation catalyst 421 constructed with manganese oxide and a lead compound as shown in FIG. 5, or active carbon 422 which adsorbs ozone and therefore naturally degrades ozone when ozone pass through as shown in FIG. 6.

The electric power part may be selected from an external electric power port 331 connecting with an external electric power source, or a battery 332 formed of a primary battery or a secondary battery mounted in the interior of ionization container 100.

The electric power part, the ionization water controller 310, and the manipulation part 320 may be housed in a container rest or base 150 of the ionization container 100. The container rest 150 is coupled to a lower-most side of the ionization container 100, and the container rest 150 might be helically engaged or connected to electrode installation part 133 by using helical threads formed to mate between container rest 150 and electrode installation part 133 or by using screws.

In accordance with the principles of the present invention, the ionization of raw water may be controlled by the ionization water controller 310. In one embodiment, the ionization water controller 310 may be implemented by a time-controlled technique based on the capacity of the ionization container 100; alternatively, in another embodiment, the ionization water controller 310 may couple to an ion sensor which senses alkaline or acidic properties of the ionized water.

The operations of the present invention will be described as follows.

The ion water device according to the present invention may include an ionization container 100 which has sufficient volume to store raw water for ionization and forms an ionization chamber 110; an ionization electrode assembly 200 disposed at one side of the ionization container 100 allowing either an anode or a cathode of the ionization electrode assembly 200 to be in direct contact with the raw water; an ionization water controller 310 disposed at one side of the ionization container 100 controls the ionization electrode assembly 200; a manipulation part 320 disposed at one side of the ionization container 100 inputting a user's manipulation signal into the ionization water controller 310; and an electric power part disposed at one side of the ionization container supplying electric power to the ionization electrode assembly 200 in accordance with a control of the ionization water controller 310. With the above construction, the structure of the construction is simplified. Therefore, it is possible to manufacture in a readily portable cylindrical bottle shaped ion water device.

When a user wants to use alkaline water according to the present invention, the user may operate the manipulation part 320 and manually input a manipulations signal into the ionization water controller 310. Accordingly, the water controller 310 controls the raw water contact electrode 220 of the ionization electrode assembly 200 to act as a cathode.

Thus, the raw water is ionized by the ionization electrode assembly 200 through an electrolysis process.

The oxygen ions, which are negatively-ionized from the raw water by the ionization electrode assembly 200, pass through the ion partition 210, and move to the externally exposed electrode 230 which acts as an anode, where the oxygen ions emit electrons and become oxygen. The oxygen generated is then emitted into the air. Meanwhile, the hydrogen ions contained in the raw water attract electrons from the raw water contact electrode 220 which acts as a cathode and the hydrogen ions are thereby converted to active hydrogen, and consequently, alkaline water is generated as the concentration of the hydroxyl ions increases relatively.

According to other embodiments, an ozone degradation chamber 410, optionally including an ozone degradation part, may be implemented at the side of the externally exposed electrode 230, so the concentration of ozone contained in the oxygen discharged to the externally exposed electrode 230 during the production of alkaline water is degraded. As a result, the negative consequence which would be otherwise caused by ozone may be reduced and the ion water device may be more safely used.

Alternatively, when the user wants to produce acidic water during the practice of the present invention, the user may operate the manipulation part 320 in order to apply to the ionization water controller 310 a signal that has been manually generated by the user in order to indicate the user's selection of acidic water, and consequently, the ionization water controller 310 controls the raw water contact electrode 220 of the ionization electrode assembly 200 to act as an anode. In this configuration, the raw water contact electrode 220 serves as an anode and continues to generate hydrogen ions and oxygen from the raw water. A portion of the hydrogen ions generated by the raw water contact electrode 220 pass through the ion partition 210, move to the externally exposed electrode 230 which acts as a cathode, where the hydrogen ions are converted into a gaseous phase of hydrogen. The generated hydrogen then escapes into ambient air. And consequently, acidic water is generated as the concentration of hydrogen ions increases. The generated acidic water may be used for cosmetic and beauty treatment, for example, for washing a face, or for cleaning purposes, such as for sterilization and disinfection.

As described above, the ion water device according to the present invention is characterized in that there is provided an ionization electrode part with only one electrode between an anode and a cathode in direct contact with the raw water with one electrolysis cell formed in an ionization container. Therefore, the structure of the ion water device is simplified, the ion water device is portable and easy to carry, the loss of raw water may be minimized during the production of ionized water, the ionized water may be selectively used depending on a user's predilections, and the functionality of the ion water device can be enhanced.

In addition, an ozone degradation part may be provided according to other embodiments of the present invention, which may reduce negative consequence by degrading a small amount of ozone that is generated during the process of alkaline water production.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds, are intended to be embraced by the appended claims.

1. An ion water device, comprising:
an ionization container storing raw water for ionization and providing an ionization chamber;
an ionization electrode provided at one side of the ionization container and comprised of one of an anode or a cathode held in direct contact with the raw water;
an ionization water controller provided at one side of the ionization container for thereby controlling and providing regulation of the ionization electrode;
a switch provided at one side of the ionization container to vary said regulation in correspondence with a manual signal applied to the ionization water controller; and
an electric power source provided at one side of the ionization container supplying electric power to the ionization electrode in accordance with said regulation; and
said ionization container comprising:
an outlet port having an open top oriented to receive raw water and to discharge ionized water and a lid closing the outlet port, an outer configuration of the outlet port being formed in a shape selected from among a cylindrical bottle shape, a rectangular bottle shape, a bucket shape and a kettle shape bearing the outlet port; and
said ionization electrode having a shape selected from among a rectangular plate shape, a cylindrical shape and a circular plate shape, said ionization electrode comprising:
a raw water contact electrode positioned to have close contact with one side of an ion partition formed by one of a proton exchange membrane and a polymer electrolyte membrane allowing only ion substances to pass through the raw water contact electrode; and
an externally exposed electrode positioned to have close contact with the ion partition on an opposite side from the raw water contact electrode and constituted to allow oxygen and ozone and hydrogen gas produced during the ionization procedure to escape into ambient atmosphere; and
said raw water contact electrode and said externally exposed electrode each comprising one of a net-shape plate or a porous pate.

2. The device of claim 1, wherein said ionization electrode is configured with a construction selected from the group consisting of:
a construction having a rectangular plate shaped electrode installation part formed at a lateral wall of one side or at a lateral wall of both sides of the ionization container, and a rectangular plate-shaped ionization electrode part coupled to the rectangular plate shape electrode installation part, and a rectangular plate shaped electrode cover is disposed so that the ionization electrode part coupled to the rectangular plate shaped electrode installation part is not exposed, and having a ventilation hole for the exhaust of the gas;
a construction having a cylindrical electrode installation part provided at an outer surface the ionization container, and the cylindrical ionization electrode part inserted into the cylindrical electrode installation part, and a cylindrical electrode disposed so that an outer surface of the ionization electrode part coupled to the cylindrical electrode installation part is not exposed, and having a ventilation hole for exhaust of gas; and
a construction having a circular plate shaped electrode installation part formed at a lower side of the ionization part, and a circular plate shaped electrode part coupled to the circular plate shaped electrode installation part.

3. The device of claim 2, wherein an insulated coating layer is formed at an outer surface of the externally exposed electrode that is not in contact with the raw water to prevent oxidation and electric leakage, and said electric power source is implemented by including an external electric power part connecting an eternal electric power grid or a battery formed of either a primary battery or a secondary battery in an interior of the device, and said electric power source, the ionization water controller and the switch are provided on a container rest of the ionization container attached to a lower side of the ionization container.

4. The device of clam 2, wherein an ozone degradation chamber is formed at the side of the externally exposed electrode in order for the ozone to be degraded to oxygen, the ozone being contained in the oxygen discharged via the externally exposed electrode when ionized water is used as alkaline water, and an ozone degradation stage is provided at the ozone degradation chamber.

5. The device of claim 4, wherein said ozone degradation stage is formed of either an ozone degradation catalyst formed from a manganese oxide and lead compound or an active carbon which adsorbs ozone and thereby naturally degrades ozone.
